(19) United States
(12) Patent Application Publication
(10) Pub. No.: US 2016/0334231 A1
(43) Pub. Date: Nov. 17, 2016

(54) COMPUTERIZED TRAVEL SAFETY SYSTEM

(71) Applicants: James F. McDonnell, Alexandria, VA (US); Bradley A. Clark, Round Hill, VA (US); Briana T. McClain, Alexandria, VA (US)

(72) Inventors: James F. McDonnell, Alexandria, VA (US); Bradley A. Clark, Round Hill, VA (US); Briana T. McClain, Alexandria, VA (US)

(21) Appl. No.: 14/708,990

(22) Filed: May 11, 2015

(51) Int. Cl. G01C 21/34; G01C 21/36

(52) U.S. Cl. CPC G01C 21/3407; G01C 21/3697

(57) ABSTRACT

A computerized travel safety system is disclosed for enabling a traveler to provide a need help feature activation signal to a remote server. The system includes a computerized processor including programming configured to monitor inputs from a mobile computerized device in the possession of the traveler, the inputs including location data for the mobile computerized device. The processor further includes programming configured to combine the inputs with a map data and provide a tactical display to a responding authority including the combined inputs and map data.

### FIELD OF THE DISCLOSURE

The present disclosure relates generally to a computerized system to manage information for traveling persons. In particular, the disclosure provides a computerized system to acquire status updates from a traveler and provide information to the traveler and about the traveler during an emergency.

### BACKGROUND

The statements in this section merely provide background information related to the present disclosure. Accordingly, such statements are not intended to constitute an admission of prior art.

Persons traveling can find themselves in any conceivable situation. Poverty, political turmoil, racial or ethnic tensions, or natural disasters can quickly turn an uneventful stay in a location into a desperate situation.

Cell phones or other mobile computerized devices are widely distributed, and many locations around the world include local cellular service, communications networks, or other similar systems over which a computerized device can send messages or data internationally.

Mobile computerized devices typically include locating systems or a locating device within the mobile device. In one exemplary embodiment, cellular devices in communication with cellular towers can quickly and accurately determine a current location for the phone based upon triangulated signals from the cellular towers. In another embodiment, global positioning satellites provide information to electronic devices, enabling the device to determine a location based upon the satellite signals. In another embodiment, proximity sensors and/or functionality provided by a Bluetooth® connection can be used to determine a location of a computerized device.

### SUMMARY

A computerized travel safety system is disclosed for enabling a traveler to provide a need help feature activation signal to a remote server. The system includes a computerized processor including programming configured to monitor inputs from a mobile computerized device in the possession of the traveler, the inputs including location data for the mobile computerized device. The processor further includes programming configured to combine the inputs with a map data and provide a tactical display to a responding authority including the combined inputs and map data.

### BRIEF DESCRIPTION OF THE DRAWINGS

One or more embodiments will now be described, by way of example, with reference to the accompanying drawings, in which:

FIG. 1 illustrates an exemplary dashboard screen for a central service provider, monitoring help requests worldwide from users registered with the service provider, in accordance with the present disclosure;

FIG. 2 illustrates an exemplary dashboard screen for a central service provider, focusing on a particular help request and a local map relative to location data provided by the user issuing the help request, in accordance with the present disclosure;

FIG. 3 illustrates a smart phone displaying buttons for a traveling user to provide status information to a remote service, in accordance with the present disclosure;

FIG. 4 illustrates the smart phone of FIG. 3, the phone displaying options to the user after a need help feature is activated, in accordance with the present disclosure;

FIG. 5 illustrates the smart phone of FIG. 3, the phone displaying instructions to the user regarding an extraction command, in accordance with the present disclosure;

FIG. 6 illustrates the smart phone of FIG. 3, wherein a need help feature has been activated and subsequently a panic button has been activated, in accordance with the present disclosure;

FIG. 7 illustrates the smart phone of FIG. 3, wherein a need help feature has been activated and the phone has been put in a find network mode, in accordance with the present disclosure;

FIG. 8 schematically illustrates an exemplary mobile computerized device such as a smart phone that can utilize the disclosed system, in accordance with the present disclosure;

FIG. 9 illustrates an exemplary tactical display that can provided to authorities in the event that a need help feature is activated, in accordance with the present disclosure; and

FIG. 10 schematically illustrates an exemplary remote server that can be operated to process information to enable the disclosed system, in accordance with the present disclosure.

### DETAILED DESCRIPTION

Non-limiting and non-exhaustive embodiments of the present disclosure are described with reference to the following figures, wherein like reference numerals refer to like parts throughout the various views unless otherwise specified.

A computerized system for providing a flow of information for a person or persons of interest, a traveler, or a group of travelers is disclosed, enabling rapid determination of a status for a monitored person and rapid coordination of efforts to aid or extract the person from a bad situation. A cell phone or other portable computerized device can be used to provide location information for the user. A cell phone or other portable computerized device can be used to present a simple interface such as a few persistent buttons upon the screen to enable the user to provide an “I'm OK” or “I need help” status on a device usually kept on a user's person.

The disclosed system can be operated by a central service, for example, a security company, a travel company, or a human resources department of a large corporation. A person wishing to travel abroad safely can purchase a membership to ABC Travel Security Company, install a software application on the person's smart phone, and travel abroad with confidence that at a moment's notice, the person can activate a request help button on the smart phone to indicate to the Company that assistance is needed and instantly provide location data from the phone. A corporation can employ a team in a foreign country and provide the team with software for the disclosed system such that in the event of an emergency, the entire team can be prompted to enter a status and provide a location. In the event of a political crisis, an embassy or other service can provide citizens with an authenticated, secure channel to provide a status and location of each of the citizens and/or a safe location to which the citizens should go for extraction.

In another embodiment, the disclosed system can be operated without a centralized service. A traveler can install software with the disclosed system on a smart phone, configure an automatic message to be sent in the case of an emergency to a proper authority or relative, and then activate the software when an emergency arises. For example, one could configure the system to send a pre-selected message with the following text and data to a local emergency service: “My name is John Smith. I am an American. I am in distress and my phone is sending my location data with this message. Please send help.” In another embodiment, a similar message could be sent to one or more pre-selected phones of friends and family, for example, providing, “It's John. I'm in Country X and I need help. Please alert authorities. My phone just emailed you my location data.” In another embodiment, for users that don't want to pay for an actively monitored service but still want a way to record a location in an emergency, a passive server can be operated by a company supplying the software, with the server recording “Please send help” location data for reference by authorities. Such a service could include an option for the user, for example, preparing for a hike in the mountains, to register their name in a publicly searchable database of registered users, such that if the person is a day late returning from the planned trip, search and rescue authorities can quickly identify that the person is a registered user the system and could have a recorded “Need help” location in the system.

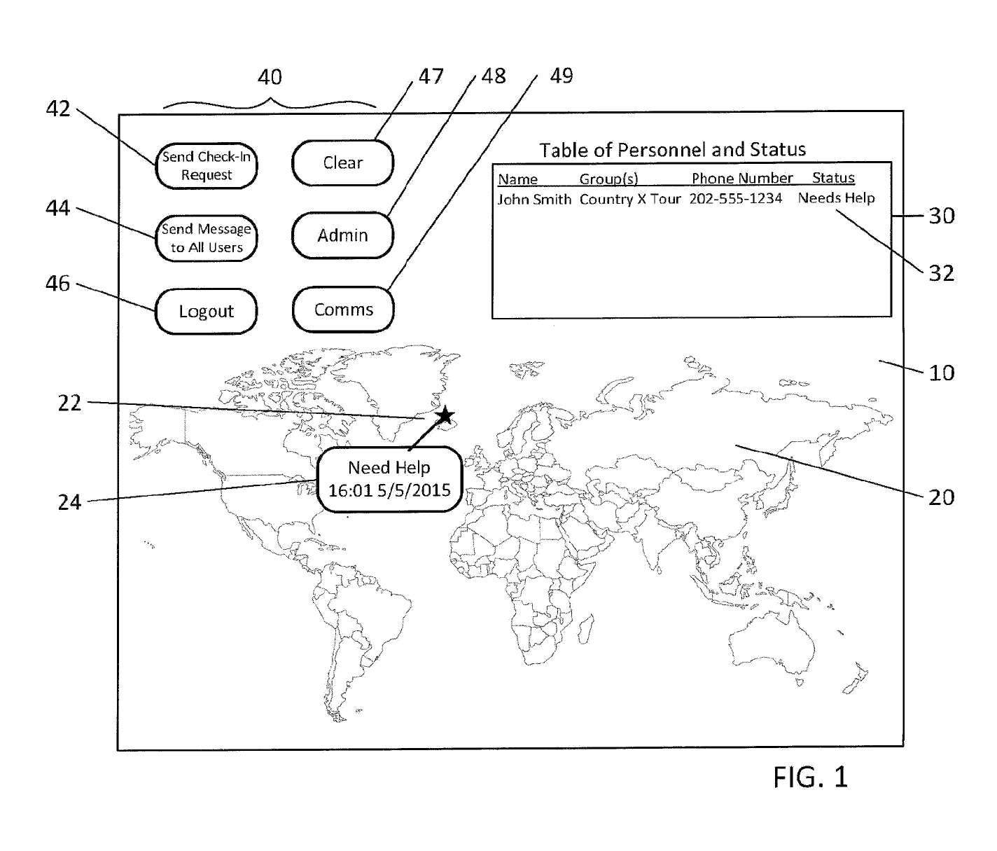

Referring now to the drawings, wherein the showings are for the purpose of illustrating certain exemplary embodiments only and not for the purpose of limiting the same, FIG. 1 illustrates an exemplary dashboard screen for a central service provider, monitoring help requests worldwide from users registered with the service provider. Dashboard home display 10 is illustrated, which enables a viewer, for example, an employee at the system service provider, to monitor and make decisions related to system users around the world. For example, a travel agency could provide a paid service whereby need help features on smart phones of travelers are monitored, and in the event any registered traveler activates the need help feature, data including location data can be transmitted to the person viewing the dashboard home display 10. It will be appreciated that accompanying audible alarms, text messages, or other similar electronic cues to the viewer of the dashboard display can be used in conjunction with a need help feature activation to ensure that attention is paid to the activation.

Dashboard display 10 is illustrated including map 20, table of personnel and status 30, and control buttons 40. Map 20 can be a world map or can automatically focus in on a country, city, or region wherein a need help activation is recorded. Star icon 22 is provided as an exemplary icon displaying in conjunction with map 20 where the user is located that has activated the need help feature. Information balloon 24 is illustrated providing information related to the activation including a time stamp. Table of personnel and status 30 is provided to provide a tabulated index of all users that have activated the need help feature. The exemplary display 10 includes a single table entry 32 corresponding to the user represented by star icon 22. Any of star icon 22, information balloon 24, and table entry 32 can be utilized as a link to contact the user, contact authorities for help, or acquire additional information about the activated feature. Exemplary buttons 40 are provided giving the person viewing display 10 an ability to take actions regarding users. Button 42 enables the viewer to request a status check-in from one or a plurality of users registered in the system or within a particular region. Button 44 enables the viewer to send a message to all users, for example, providing details about a natural disaster or unrest in a particular country. Button 47 enables the viewer to clear information from the screen, for example, to focus upon a particular user. In one embodiment, a system administrator or supervisor would be required to clear a need help activation to avoid clearing data related to an active need for help. Button 48 enables administrative access to the system, for example, permitting a system administrator to clear a confirmed accidental activation of a need help feature or to make a communication contact with a user or a government agency which requires an administrator's authorization. Button 49 enables communication options to be displayed to the user, for example, permitting the viewer to make an inquiry to a particular user, a supervisor or a system administrator, governmental authorities, disaster experts, or other personnel. Button 46 permits the viewer to logout from the system, for example, to hand off responding authority to another viewer.

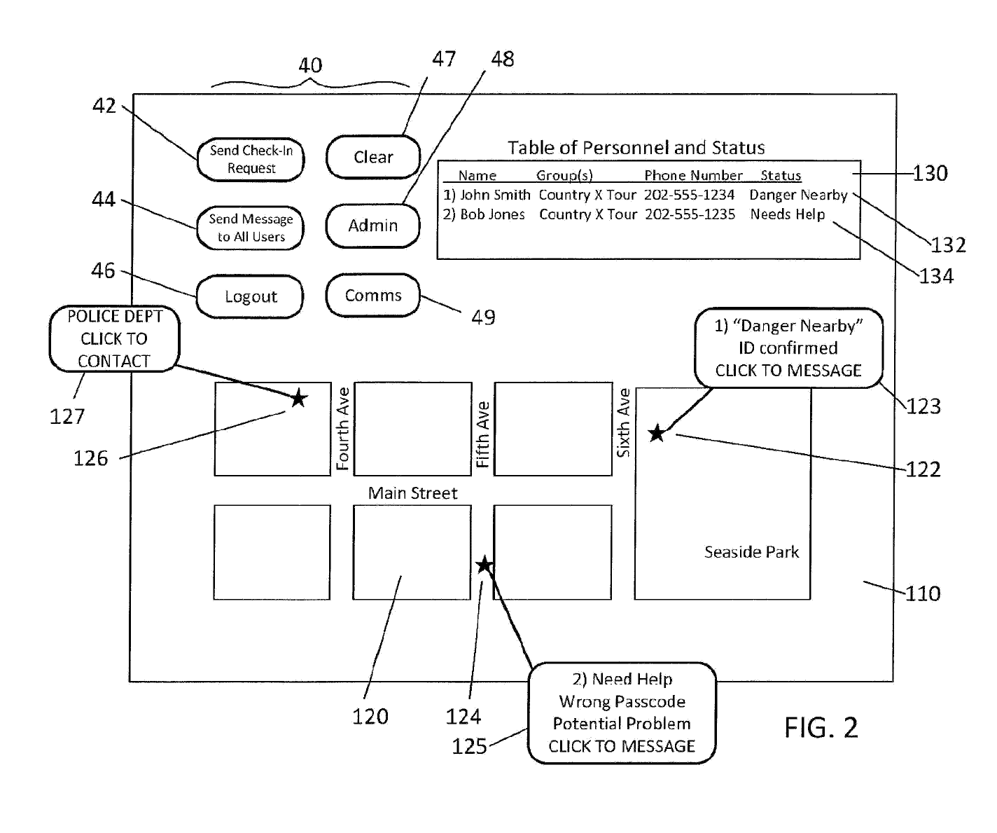

FIG. 2 illustrates an exemplary dashboard screen for a central service provider, focusing on a particular help request and a local map relative to location data provided by the user issuing the help request. Dashboard display 10 is illustrated, for example, including information that can be displayed after a display viewer has selected a particular user or region to focus upon from display 10 of FIG. 1. Display 110 is illustrated including city level map 120, table of personnel and status 130, and control buttons 40. City level map 120 includes information related to two users that have activated need help features. A first user activated the feature, and corresponding location data is used to display star icon 122 illustrating a last known or current position of the first user on map 120. Information balloon 123 is provided, giving detailed information related to the first user. In this example, after activating the need help feature, the user entered text “Danger Nearby” in the mobile device carried by the first user. Balloon 123 also prompts the viewer to click on the balloon to send a textual message to the user. A second user also activated the feature, and corresponding location data is used to display star icon 124 illustrating a last known or current position of the second user on map 120. Information balloon 125 is provided, giving detailed information related to the first user. In this example, after activating the need help feature, a prompt to enter a security code was responded to inaccurately. Depending upon the protocols of the viewer and the system administrator, the second user can be contacted or an assumption can be made that the user's phone could have been compromised by a bad actor. Additional locations or services of interest can be displayed on map 120. For example, a police station near to the illustrated user locations is provided upon display 120 by star icon 126. Information balloon 127 is provided identifying information related to the police station represented to icon 126. In one embodiment, the viewer can easily contact the police station by clicking on icon 126 or balloon 127. In another embodiment, the viewer can post information upon the displays of either smart phone of the users or automatically connect one of the users to an emergency police line, for example, by clicking and dragging balloon 127 to icons 122 and 124.

Table of personnel and status 130 is illustrated, including detailed entries 132 and 134 for each of the first user and the second user. In one embodiment, only users activating a need help feature can be listed in table 130. In another embodiment, entries 132 and 134 are highlighted or otherwise emphasized, while other users in the area are additionally displayed to provide the viewer with an ability to contact or warn other users close to the activating users.

Buttons 40 including buttons 42, 44, 46, 47, 48, and 49 with similar functionality to buttons 40 of FIG. 1. The illustrated buttons are provided as non-limiting examples of options and responses that can be provided to the viewer of display 110. Displays 10 and 110 can be provided upon any computerized device, for example, in communication with a remote server processing information related to the users registered in the system. In one embodiment, displays 10 and 110 can selectively be made available by a viewer or a system administrator to government agencies, emergency responders, or security personnel, for example, by publishing the display information to an accessible website.

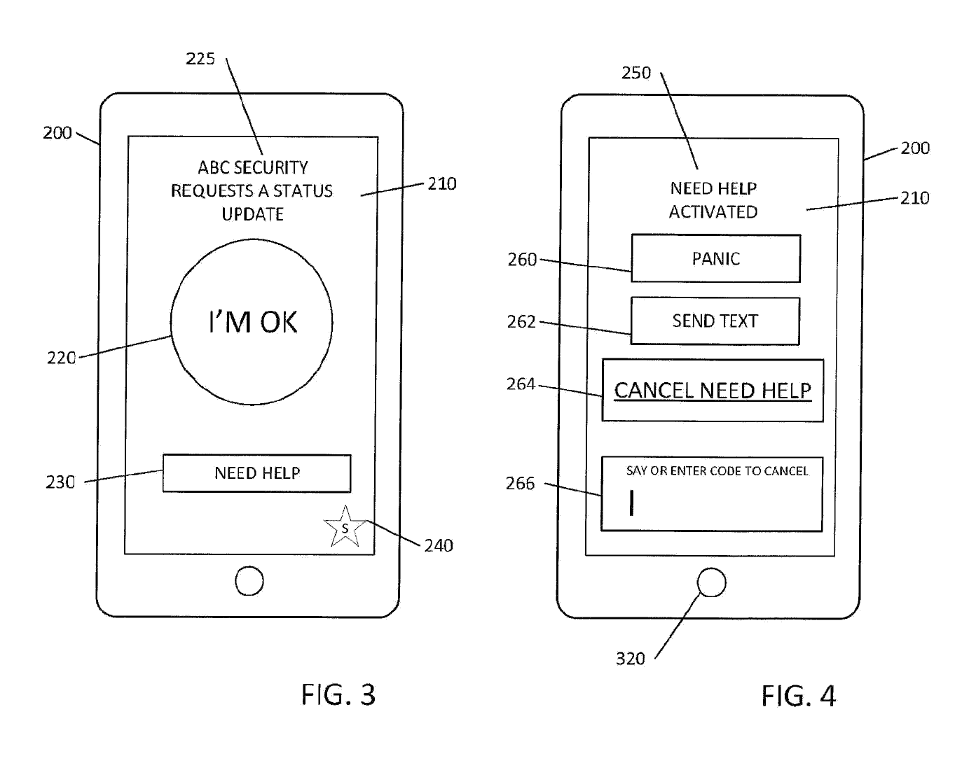

FIG. 3 illustrates a smart phone displaying buttons for a traveling user to provide status information to a remote service. A mobile computerized device embodied as smart phone 200 is illustrated. Smart phone 200 includes touch-screen display 210. Although smart phones are used to illustrate exemplary mobile computerized devices throughout the disclosure, other portable computerized devices including tablet computers, computerized eyeglasses or wrist watches, flip-phones, or any other similar devices could be utilized with the disclosed system, and the disclosure is not intended to be limited to the particular examples provided herein. Smart phone 200 is in communication with a remote server or other remote computerized system coordinating information in accordance with the disclosure.

Display 210 illustrates an exemplary check-in request display, which can, for example, be provided based upon a request of the user of the smart phone or based upon a request made by a remote viewer of a dashboard display or system administrator. Banner 225 can be displayed providing the user with some context for the request. The user of smart phone 200 is prompted to enter a response upon display 210 that the user is in a normal condition and unaware of any danger through button 220 or that the user wishes to activate the need help feature through button 230. Additionally, a settings button 240 can be provided to the user, for example, enabling the user to opt out of requests from the service provider or to access more options than the two provided buttons, for example, connecting the user to the service provider by phone call.

FIG. 4 illustrates the smart phone of FIG. 3, the phone displaying options to the user after a need help feature is activated. Once a need help feature is activated on a smart phone or other device, the alert and corresponding information such as location data can be sent out immediately. In one embodiment, a second display can be provided upon display 210 of smart phone 200, giving the user additional information and options. For example, banner 250 confirms for the user that the need help activation has been accomplished and received by the service provider. Button 260 can be provided, enabling the user to express a panic condition. Button 262 can be provided, enabling the user to provide specific text regarding the need help function activation, for example, specifying “I'm lost” or “I see men with guns,” thereby enabling the viewer of the system provider to take appropriate action. Button 264 can be provided, for example, enabling the user to cancel the activation. Such a cancellation can be enabled with a single click of the cancel button. In another embodiment, a pass code can be required to cancel the alert. Depending upon the particular situation or protocols of the service provider, an incorrect entry of a cancel pass code can prompt re-entry of the number or can be used to make the assumption that the user could have been taken captive and the phone confiscated. Under such an assumption, the display could be used to provide a “alert canceled—have a nice day” message to the phone viewer while actually prompting action through the service provider.

Entry of a pass code can take a number of forms, for example, with text entry through touch screen, voice activation, or exemplary finger print scan reading through activation button 320. In one embodiment, users can be coached that a thumb scan is actually a request for help, while an index finger scan is actually used to cancel the alert.

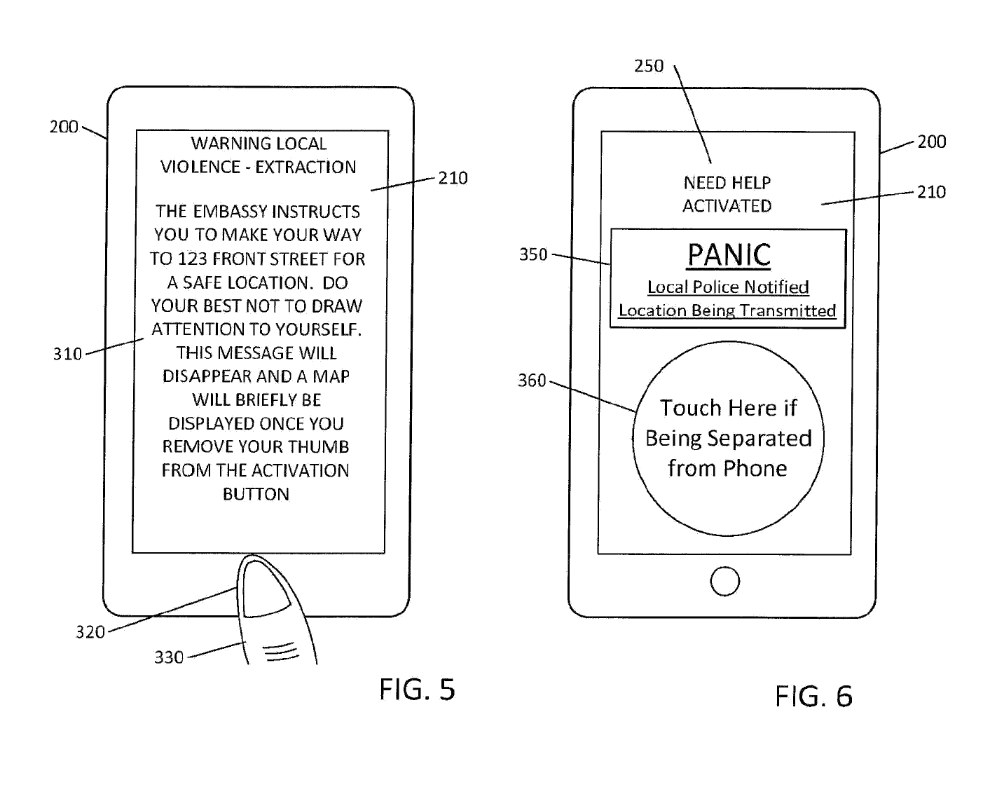

FIG. 5 illustrates the smart phone of FIG. 3, the phone displaying instructions to the user regarding an extraction command. When a security incident occurs in a remote location, government agencies can become involved, for example, to extract citizens of a certain country from a city or region. Instructions from the government agency to registered users can be displayed upon display 210 of smart phone 200. In some situations, wherein multiple people are being directed to a single safe house, and wherein suspects are reported to be attempting to intercept and capture those seeking the safe house, it can be advantageous not to have information about the safe house persistently kept upon the smart phones of the users. Message 310 relates important information to the user while explaining to the user that the information is no longer going to be available for viewing after the user's thumb 330 is removed from activation button 320. In this way, sensitive information can be relayed to users while preventing the information from falling into the wrong hands.

FIG. 6 illustrates the smart phone of FIG. 3, wherein a need help feature has been activated and subsequently a panic button has been activated. Smart phone 200 including display 210 includes banner 250 confirming for the user that the need help function has been activated. Further, a panic button 250, once depressed, can be enlarged and caused to glow or pulse to visually confirm for the user that the panic feature has been activated. Such a panic feature can activate a number of exemplary protocols with the service provider, for example, automatically contacting a 9-1-1 operator or similar emergency service in the locale of the user and persistently transmitting location information to the service provider. Button 360 is provided enabling the user to further signal that the phone is likely about to be taken from the user. In another exemplary embodiment, button 360 can include text instructing the user to place a finger upon the button, with the assumption that, if the finger is removed, the phone has been taken from the user.

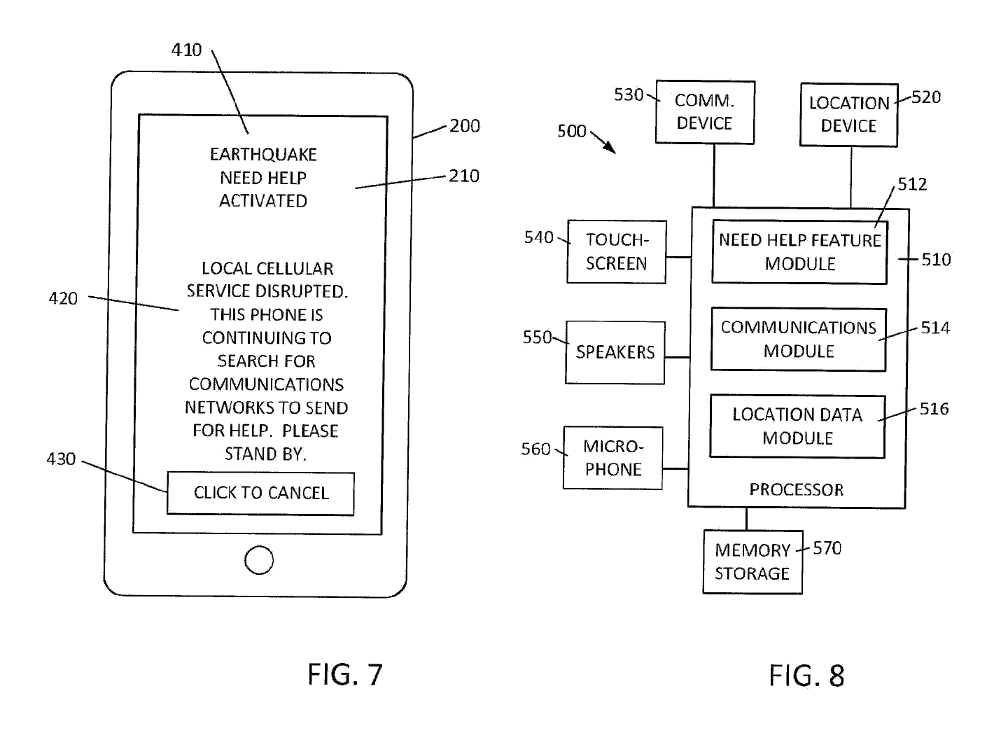

FIG. 7 illustrates the smart phone of FIG. 3, wherein a need help feature has been activated and the phone has been put in a find network mode. Smart phone 200 including display 210 is illustrated. Banner 410 is illustrated, providing information to the user, for example, that the region that the user is in has experienced an exemplary earthquake. Further, banner 410 can confirm for the user that the need help feature has been activated and whether the feature activation has been received and acknowledged by the service provider. In the exemplary display of FIG. 7, the user is notified through message 420 that local communications service has been disrupted and that the need help activation has not been confirmed as received by the service provider. However, the message 420 provides the user with the assurance that the phone is continuing to attempt to send the activation information to the service provider. Button 430 is provided enabling the user to cancel the process of the phone searching for a communications network, for example, to conserve the batteries of the device.

FIG. 8 schematically illustrates an exemplary mobile computerized device such as a smart phone that can utilize the disclosed system. Configuration 500 is exemplary of systems and devices within smart phone 200. Configuration 500 includes a processor 510 configured to operate programmed code, RAM memory, and durable memory storage 570 embodied as a hard drive, flash memory, or other similar devices. Processor 510 operates programming modules which are configured to operate programming accomplishing various aspects of the disclosed system. The programming modules provided herein may exist on a single device or may span multiple devices and are provided as a non-limiting example of how processes described herein can be operated.

Processor 510 includes a communication module 514 which utilizes a connected communications device 530 to communicate wirelessly with a remote server or other devices over a communications network such as a cellular network. Processor 510 further includes an need help feature module 512 configured to process commands from a remote server or monitor user inputs to the device and operate programming within processor 510 to implement steps or stages in a process based upon the need help feature activation. Processor 510 further includes a location data module 516 including programming to provide location data of the user to a remote server at the permission of the user of the device.

Configuration 500 further includes a touch screen device 540, speakers 550, a microphone device 560, and a location device 520. Configuration 500 is exemplary, and the disclosure is not intended to be limited to the particular examples provided herein related to computerized devices.

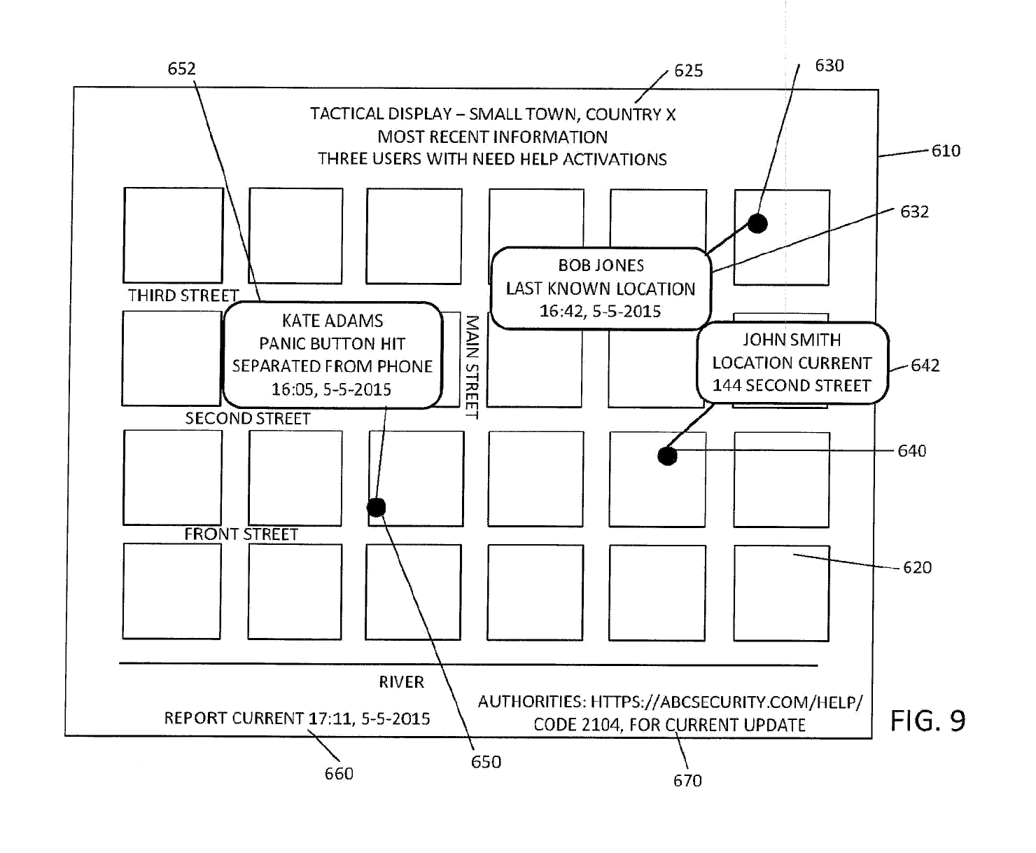

FIG. 9 illustrates an exemplary tactical display that can provided to authorities in the event that a need help feature is activated. Display 610 includes information that can be quickly passed off or provided to an emergency responder regarding the latest known information for users in an area that have activated need help features according to the disclosed system. Such a display is configured to be viewed in real-time, for instance, by a government agency coordinator or officer, so that information can be relaying through verbal communications to responders on the ground. In another embodiment, the information on the display is intended to be able to be provided as a screen capture or a paper print out to responders for easy distribution. Exemplary local map 620 is included. Banner 625 provides details related to tactical display 610. Data related to last known locations of three registered users is provided through circle icons 630, 640, and 650, each including respective information balloons 632, 642, and 652. Information balloon 632 provides last known location data for a first user including a time and date stamp. Information balloon 642 includes a determined address at which a second user is confirmed to currently occupy. Information balloon 652 provides last known location data for a third user, including information that the user activated a panic button and was separated from her phone. The display optionally includes a current time stamp 660 so that a viewer can easily determine how old the information is and information 670 or an active link to current update information provided by the service provider.

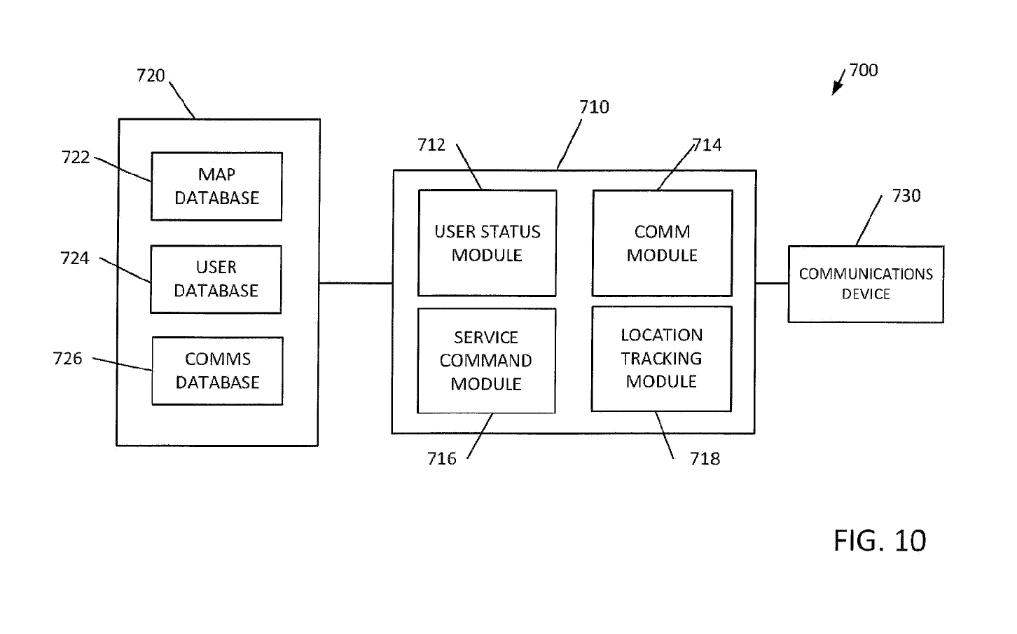

FIG. 10 schematically illustrates an exemplary remote server that can be operated to process information to enable the disclosed system. Configuration 700 is illustrated including Memory storage 720, processing device 710, and communications device 730. Configuration 700 includes processing device 710 configured to operate programmed code, RAM memory, and access data from memory storage 812, the storage embodied as a hard drive, flash memory, or other similar devices. Processing device 710 operates programming modules which are configured to operate programming accomplishing various aspects of the disclosed system. The programming modules provided herein may exist on a single device or may span multiple devices and are provided as a non-limiting example of how processes described herein can be operated.

Processor 710 provides and receives information to/from communication device 730, communicating wirelessly with other remote servers, computerized devices, and other systems over a communications network such as a cellular network. Processor 710 includes a user status module 712, a communications module 714, a service command module 716, and a location tracking module 718. User status module 710 includes programming to process data related to a plurality of users in different locations and correlated status data for each of the users. Communications module 714 includes programming enabling the service provider to contact users, local authorities, government agencies, emergency responders, and other personnel corresponding to a need help activation in a particular locale. Service command module 716 includes programming configured to provide a dashboard display to a viewer at the service provider, enable the viewer to share that display with other personnel, provide information and prompt requests to the users, and the other functionality enabled for the display viewer as disclosed herein. Location tracking module 718 includes programming to process information related to smart phone location data as provided by user's devices.

Memory storage 720 includes map database 722, user database 724, and communications database 726. Map database 722 includes information locations around the world so that location data can be combined with geographical information to provide a useful display to the viewer at the service provider. User database 724 includes stored information about various devices enabled for use with the disclosed system. Communications database 726 includes stored information for use in communicating between various devices and remote systems as is required to operate the disclosed system.

Communications between the server and various devices of the disclosed system can be accomplished through a number of different communications connections or services known in the art. For example, a cellular connection can be utilized for two devices to communicate with each other. In other embodiments, telephone lines; broadband, digital subscriber line, or other internet connections; local area network or wireless local area networks; Bluetooth® connections; or other similar communications services can be utilized in accordance with the disclosed system.

The above description of illustrated examples of the present disclosure, including what is described in the Abstract, are not intended to be exhaustive or to be limited to the precise forms disclosed. While specific embodiments of, and examples for, the disclosure are described herein for illustrative purposes, various equivalent modifications are possible without departing from the broader spirit and scope of the present disclosure. Indeed, it is appreciated that the specific example values, times, etc., are provided for explanation purposes and that other values may also be employed in other embodiments and examples in accordance with the teachings of the present disclosure.

1. A computerized travel safety system enabling a traveler to provide a need help feature activation signal, comprising:
computerized processor including programming configured to:
monitor inputs from a mobile computerized device in possession of the traveler, the inputs including location data for the mobile computerized device;
combine the inputs with map data; and
provide a tactical display to a responding authority comprising the combined inputs and map data.

2. The system of claim 1, wherein monitoring the inputs from the mobile computerized device comprises monitoring an input indicating that the traveler is safe and an input indicating that the traveler needs assistance.

3. The system of claim 2, wherein the programming configured to monitor the inputs is initiated by the traveler.

4. The system of claim 2, wherein the programming configured to monitor the inputs is initiated by a system administrator.

5. The system of claim 2, wherein the programming configured to monitor the inputs comprises a status update request sent to a plurality of mobile computerized devices initiated by a system administrator.

6. The system of claim 2, wherein monitoring the inputs from the mobile computerized device further comprises, after monitoring the input indicating that the traveler needs assistance, monitoring activation of a panic status.

7. The system of claim 2, wherein monitoring the inputs from the mobile computerized device further comprises, after monitoring the input indicating that the traveler needs assistance, monitoring activation of a indication that the traveler is being separated from the mobile computerized device.

8. The system of claim 1, wherein the computerized processor further includes programming configured to provide the tactical display to a third party.

9. The system of claim 1, wherein providing the tactical display to a responding authority comprising the combined inputs and map data comprises displaying a last known location for the mobile computerized device.

10. The system of claim 1, wherein providing the tactical display to a responding authority comprising the combined inputs and map data comprises displaying a authentication information for the mobile computerized device.

11. The system of claim 1, wherein providing the tactical display to a responding authority comprising the combined inputs and map data comprises displaying a textual message entered by the traveler.

12. The system of claim 1, wherein the computerized processor further includes programming configured to display a message from the responding authority upon the mobile computerized device.

13. The system of claim 12, wherein the programming configured to display the message from the responding authority is configured to only display the message temporarily.

14. The system of claim 12, wherein the programming configured to display the message from the responding authority is configured to only display the message while the traveler depresses an activation button.

15. A computerized travel safety system enabling a traveler to provide a need help feature activation signal, comprising:
computerized processor including programming configured to:
monitor inputs from a plurality of mobile computerized devices, each of the devices in possession of one of a group of travelers, the inputs including location data for the mobile computerized devices;
combine the inputs with map data; and
provide a tactical display to a responding authority comprising the combined inputs and map data.

16. The system of claim 15, wherein providing the tactical display comprises selecting a portion of the group of travelers based upon geographical area.
